(19) United States
(12) Patent Application Publication
(10) Pub. No.: US 2018/0279597 A1
(43) Pub. Date: Oct. 4, 2018

(54) TELESCOPIC FISHING ROD CARRYCASE

(71) Applicant: Danny Wilson, Orlando, FL (US)

(72) Inventor: Danny Wilson, Orlando, FL (US)

(21) Appl. No.: 15/477,242

(22) Filed: Apr. 3, 2017

(51) Int. Cl. A01K 97/08

(52) U.S. Cl. CPC A01K 97/08

(57) ABSTRACT

A telescopic fishing rod carrycase for storing and transporting a fishing rod comprises a primary hollow compartment (PHC), a docking attachment, a first hollow casing (FHC), a second hollow casing (SHC), a third hollow casing (THC), and a locking mechanism. The PHC comprises an outer surface and an inner surface. The docking attachment is detachably attached to a projection positioned on the outer surface of the PHC for securing the fishing rod. The outer surface of the FHC is slidably engaged to the inner surface of the PHC. The outer surface of the SHC is slidably engaged to the inner surface of the FHC. The outer surface of the THC is slidably engaged to the inner surface of the SHC. The locking mechanism restrains the FHC, SHC, and THC in an extended position. The FHC, SHC, and THC together store the fishing rod.

The invention disclosed herein relates in general to a carrycase for storing and transporting a fishing rod. More particularly, the invention disclosed herein relates to telescopic carrycases, which are extendable and retractable, for storing fishing rods of varying dimensions.

### BACKGROUND

Fishing refers to the activity of catching fish using various apparatus such as fishing rods or fishing tackle equipped with fishing lines. In addition to providing food, fishing also constitutes a recreational activity. Users typically transport fishing rods between home and a fishing location in a vehicle or carry them by hand. Traditional fishing rods are usually expensive and users cannot afford damage to the fishing rods, especially while transporting to remote locations. However, during transportation, the fishing rods are exposed to accidental impact caused by surrounding objects or hard surfaces of the vehicle, thereby damaging the fishing rod. Therefore, a carrycase, which suitably protects the fishing rod during transportation, is required. Furthermore, fishing rods may be of varying sizes or of a telescopic type. Conventional fishing rod carrycases can accommodate only a particular type or size of fishing rod. A carrycase, which is capable of accommodating fishing rods of varying sizes, is thus required.

Hence, there is a long felt, but unresolved need for a fishing rod carrycase, which suitably protects the fishing rod during transportation and storage. Furthermore, there is a need for a fishing rod carrycase device, which is capable of accommodating fishing rods of varying sizes.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The telescopic fishing rod carrycase disclosed herein addresses the above-mentioned need for a fishing rod carrycase, which protects the fishing rod during transportation. Furthermore, the telescopic fishing rod carrycase addresses the need for a fishing rod carrycase, which is capable of accommodating fishing rods of varying sizes. The telescopic fishing rod carrycase for storing and transporting a fishing rod comprises a primary hollow compartment, a docking attachment, a first hollow casing, a second hollow casing, a third hollow casing, and a locking mechanism. The primary hollow compartment comprises an outer surface and an inner surface. The docking attachment is detachably attached to a projection positioned on the outer surface of the primary hollow compartment for securing the fishing rod. The first hollow casing comprising an outer surface and an inner surface.

The outer surface of the first hollow casing is slidably engaged to the inner surface of the primary hollow compartment. The second hollow casing comprises an outer surface and an inner surface. The outer surface of the second hollow casing is slidably engaged to the inner surface of the first hollow casing. The third hollow casing comprises an outer surface and an inner surface. The outer surface of the third hollow casing is slidably engaged to the inner surface of the second hollow casing. The locking mechanism restrains one or more of the first hollow casing, the second hollow casing, and the third hollow casing in an extended position. The first hollow casing, the second hollow casing, and the third hollow casing together store the fishing rod.

Other aspects, advantages, and novel features of the present invention will become apparent from the following detailed description in conjunction with the drawings.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a front perspective view of a telescopic fishing rod carrycase.

FIG. 2 exemplarily illustrates a rear perspective view of a telescopic fishing rod carrycase.

FIG. 3 exemplarily illustrates a front elevation view of a telescopic fishing rod carrycase.

FIG. 4 exemplarily illustrates a rear elevation view of a telescopic fishing rod carrycase.

FIG. 5 exemplarily illustrates a right side elevation view of a telescopic fishing rod carrycase.

FIG. 6 exemplarily illustrates a rear perspective view of a fishing rod and a telescopic fishing rod carrycase.

FIG. 7 exemplarily illustrates a rear perspective view of a telescopic fishing rod carrycase, showing a docking attachment attaching a fishing rod to the telescopic fishing rod carrycase.

FIG. 8 exemplarily illustrates a right side elevation view of a telescopic fishing rod carrycase, showing a docking attachment attaching a fishing rod to the telescopic fishing rod carrycase.

FIG. 9 exemplarily illustrates a front perspective view of a telescopic fishing rod carrycase, showing a docking attachment attaching a fishing rod to the telescopic fishing rod carrycase.

FIG. 10 exemplarily illustrates a front elevation view of a telescopic fishing rod carrycase, showing a docking attachment attaching a fishing rod to the telescopic fishing rod carrycase.

### DETAILED DESCRIPTION OF THE INVENTION

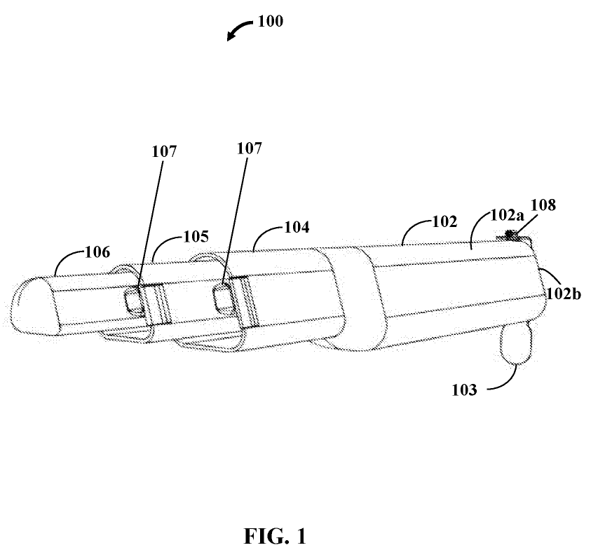

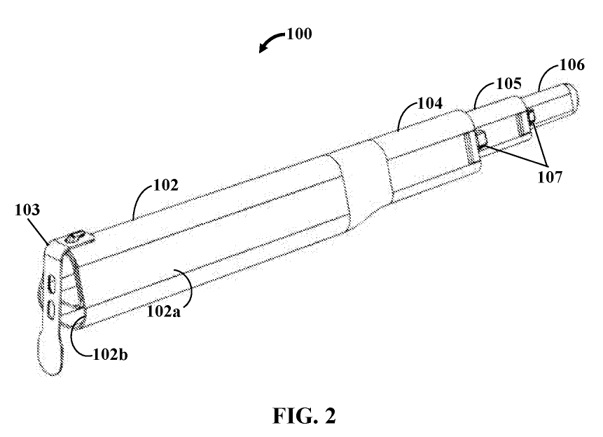

FIG. 1 exemplarily illustrates a front perspective view of a telescopic fishing rod carrycase 100. FIG. 2 exemplarily illustrates a rear perspective view of a telescopic fishing rod carrycase 100. The telescopic fishing rod carrycase 100 for storing and transporting a fishing rod 101 comprises a primary hollow compartment 102, a docking attachment 103, a first hollow casing 104, a second hollow casing 105, a third hollow casing 106, and a locking mechanism 107. The primary hollow compartment 102 comprises an outer surface 102a and an inner surface 102b. The docking attachment 103 is detachably attached to a projection 108 positioned on the outer surface 102a of the primary hollow compartment 102 for securing the fishing rod 101. In an embodiment, the docking attachment 103 comprises slots 103a for adjustably attaching a fishing rod to the telescopic fishing rod carrycase 100. (Please verify the correctness of the highlighted statement.) The first hollow casing 104 comprising an outer surface 104a and an inner surface 104b. The outer surface 104a of the first hollow casing 104 is slidably engaged to the inner surface 102b of the primary hollow compartment 102. The second hollow casing 105 comprises an outer surface 105a and an inner surface 105b. The outer surface 105a of the second hollow casing 105 is slidably engaged to the inner surface 104b of the first hollow casing 104. The third hollow casing 106 comprises an outer surface 106a and an inner surface 106b. The outer surface 106a of the third hollow casing 106 is slidably engaged to the inner surface 105b of the second hollow casing 105. The locking mechanism 107 restrains one or more of the first hollow casing 104, the second hollow casing 105, and the third hollow casing 106 in an extended position. The first hollow casing 104, the second hollow casing 105, and the third hollow casing 106 together store the fishing rod.

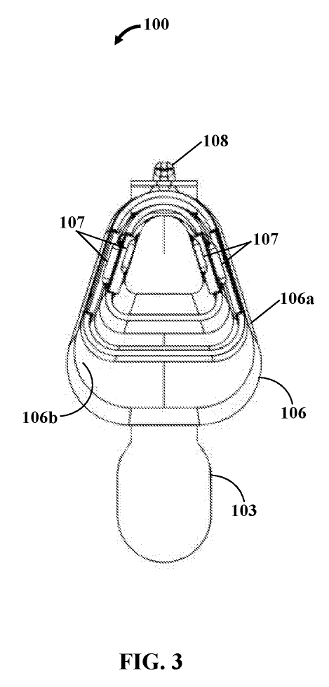

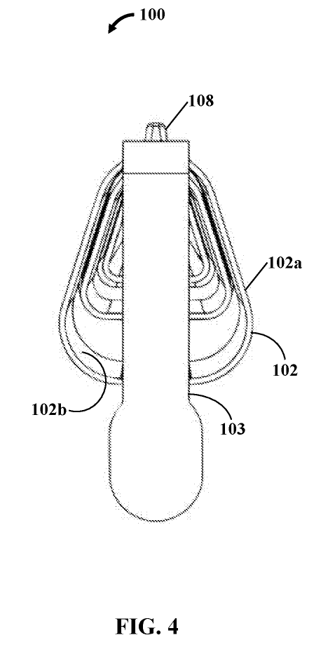

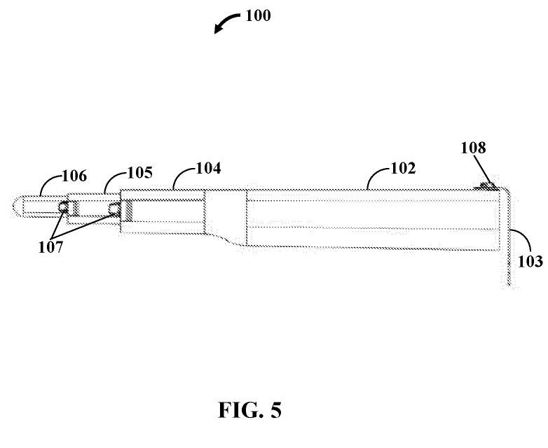

FIG. 3 exemplarily illustrates a front elevation view of a telescopic fishing rod carrycase 100. FIG. 4 exemplarily illustrates a rear elevation view of a telescopic fishing rod carrycase 100. FIG. 5 exemplarily illustrates a right side elevation view of a telescopic fishing rod carrycase 100. In an embodiment, the telescopic fishing rod carry case 100 is made of various materials, for example, nylon, PVC, aluminum, etc. Furthermore, in an embodiment, the telescopic fishing rod carrycase 100 is foam padded to prevent damage to the fishing rod 101. (Please verify the correctness of the highlighted statements.) The projection 108 is positioned at the rear of the telescopic fishing rod carrycase 100 as exemplarily illustrated in FIGS. 3-5. The docking attachment 103 is securely attached to the projection 108 positioned on the telescopic fishing rod carrycase 100. The locking mechanism 107 prevents the extended telescopic fishing rod carrycase 100 from retracting as exemplarily illustrated in FIG. 5.

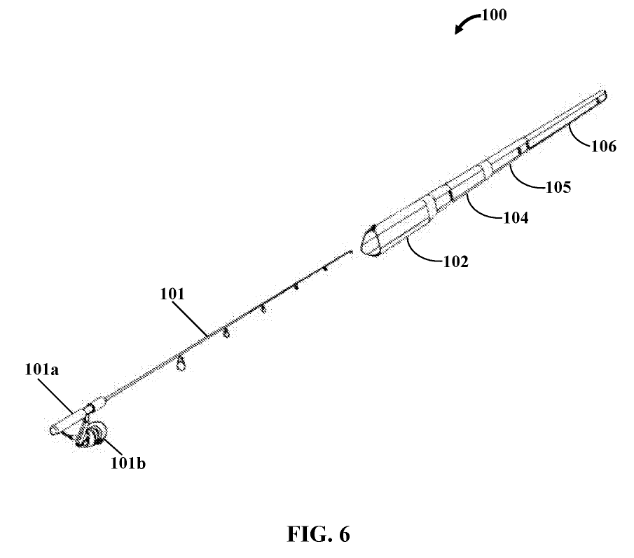

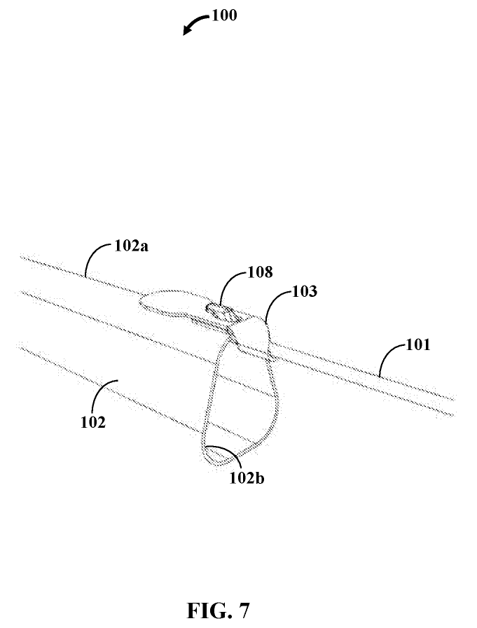

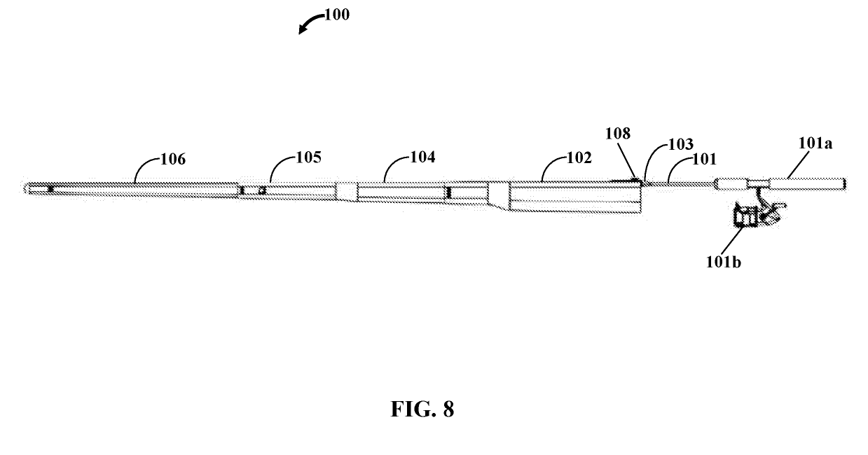

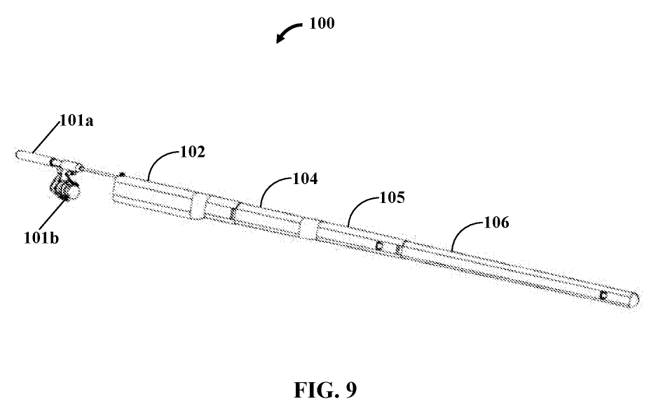

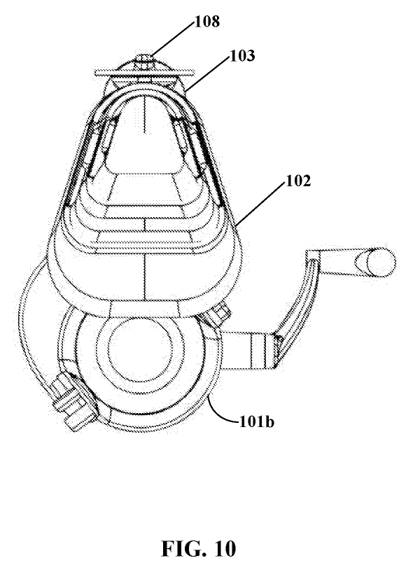

FIG. 6 exemplarily illustrates a rear perspective view of a fishing rod and a telescopic fishing rod carrycase 100. FIG. 7 exemplarily illustrates a rear perspective view of a telescopic fishing rod carrycase 100, showing a docking attachment attaching a fishing rod to the telescopic fishing rod carrycase 100. FIG. 8 exemplarily illustrates a right side elevation view of a telescopic fishing rod carrycase 100, showing a docking attachment attaching a fishing rod to the telescopic fishing rod carrycase 100. FIG. 9 exemplarily illustrates a front perspective view of a telescopic fishing rod carrycase 100, showing a docking attachment attaching a fishing rod to the telescopic fishing rod carrycase 100. FIG. 10 exemplarily illustrates a front elevation view of a telescopic fishing rod carrycase 100, showing a docking attachment attaching a fishing rod to the telescopic fishing rod carrycase 100. In an embodiment, the fishing rod 101 comprises a handle 101a and a reel 101b as exemplarily illustrated in FIGS. 6-10. When a user wishes to keep his/her fishing rod 101 in the telescopic fishing rod carrycase 100, he/she inserts the fishing rod 101 to the rear of the telescopic fishing rod carrycase 100 as exemplarily illustrated in FIG. 6. The user then secures the fishing rod 101 to the projection 108 positioned on the outer surface 102a of the primary hollow compartment 102 via the docking attachment 103 as exemplarily illustrated in FIG. 7. The inserted fishing rod 101 is then stored or transported while being secured to the telescopic fishing rod carrycase 100 as exemplarily illustrated in FIGS. 8-10.

The foregoing examples have been provided merely for the purpose of explanation and are in no way to be construed as limiting of the telescopic fishing rod carrycase 100, disclosed herein. While the telescopic fishing rod carrycase 100 has been described with reference to various embodiments, it is understood that the words, which have been used herein, are words of description and illustration, rather than words of limitation. Further, although the telescopic fishing rod carrycase 100 has been described herein with reference to particular means, materials, and embodiments, the telescopic fishing rod carrycase 100 is not intended to be limited to the particulars disclosed herein; rather, the telescopic fishing rod carrycase 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the telescopic fishing rod carrycase 100 disclosed herein in their aspects.

What is claimed is:

1. A telescopic fishing rod carrycase for storing and transporting a fishing rod comprising:
a primary hollow compartment comprising an outer surface and an inner surface;
a docking attachment detachably attached to a projection positioned on the outer surface of the primary hollow compartment for securing the fishing rod;
a first hollow casing comprising an outer surface and an inner surface, wherein the outer surface of the first hollow casing is slidably engaged to the inner surface of the primary hollow compartment;
a second hollow casing comprising an outer surface and an inner surface, wherein the outer surface of the second hollow casing is slidably engaged to the inner surface of the first hollow casing;
a third hollow casing comprising an outer surface and an inner surface, wherein the outer surface of the third hollow casing is slidably engaged to the inner surface of the second hollow casing;
a locking mechanism for restraining one or more of the first hollow casing, the second hollow casing, and the third hollow casing in an extended position; and
wherein the first hollow casing, the second hollow casing, and the third hollow casing together store the fishing rod.

2. The telescopic fishing rod carrycase of claim 1, wherein the docking attachment comprises a plurality of slots for adjustably securing the fishing rod.

3. The telescopic fishing rod carrycase of claim 1, wherein the first hollow casing, the second hollow casing, and the third hollow casing are of different colors.

4. The telescopic fishing rod carrycase of claim 1, wherein the first hollow casing, the second hollow casing, and the third hollow casing are of a single color.
